(19) United States
(12) Patent Application Publication
(10) Pub. No.: US 2025/0223713 A1
(43) Pub. Date: Jul. 10, 2025

(54) ELECTROCHEMICAL CELL FOR A HIGH-PRESSURE ELECTROLYSER

(71) Applicant: Siemens Energy Global GmbH & Co. KG, München (DE)

(72) Inventors: Simon Kiesslich, Erlangen (DE); Alexander Spies, Kemnath (DE); Jochen Straub, Erlangen (DE)

(21) Appl. No.: 18/850,691

(22) PCT Filed: Dec. 27, 2022
(86) PCT No.: PCT/EP2022/087859

§ 371 Date: Sep. 25, 2024

(30) Foreign Application Priority Data
Mar. 25, 2022 (DE) 10 2022 202 986.0

(51) Int. Cl. C25B 9/63; C25B 9/05; C25B 9/77

(52) U.S. Cl. CPC C25B 9/63; C25B 9/05; C25B 9/77

(57) ABSTRACT

An electrochemical cell for a high-pressure electrolyzer contains a closed cell frame made of a high-pressure-resistant first material; an electrochemical reaction region, which is arranged completely inside the cell frame and contains an anodic half-cell and a cathodic half-cell; a gap, which spatially separates the reaction region from the cell frame; and a second material introduced into the gap. The second material is an electrical insulator, and the second material has a lower diffusion coefficient with respect to the entry of foreign ions into the reaction region. A plurality of the electrochemical cells are used to form a cell stack and the cell stack is used to form a high-pressure electrolyzer.

The invention relates to an electrochemical cell, more particularly an electrolysis cell for a high-pressure electrolyzer.

Known electrolysis plants have a multitude of electrochemical cells, referred to as the electrolysis cells. These cells are greatly employed in the conversion of chemicals into different chemicals under the effect of electricity.

Generally speaking, a chemical reaction, i.e., transformation of matter, is brought about with the aid of an electrical current.

For example, hydrogen is presently generated by means of proton exchange membrane (PEM) electrolysis or alkaline electrolysis. These electrolysis plants then use electrical energy to produce hydrogen and oxygen from the water supplied.

An electrolysis plant here comprises a multitude of electrochemical cells arranged adjacently to one another. By means of water electrolysis, for example, water is broken down into hydrogen and oxygen in the electrolysis cells. In the case of a PEM electrolyzer, water distilled on the anode side is typically supplied as reactant and split into hydrogen and oxygen at a proton-permeable membrane (proton exchange membrane; PEM). The water here is oxidized to oxygen at the anode. The protons pass through the proton-permeable membrane. Hydrogen is produced on the cathode side. The water here is generally conveyed from a bottom side into the anode space and/or cathode space.

For future applications, there is increasing contemplation of electrolysis plants which operate under high or very high operating pressure in the electrolysis cell, these being referred to as high-pressure electrolyzers. This development already poses challenging technical conditions regarding the mechanical layout and manufacture at the level of the electrolysis cell for high-pressure operation and also for a high-pressure electrolyzer and the safe operation thereof from a variety of standpoints. Accordingly, an electrolysis cell must be considered as a pressure-carrying device, pressure device or pressure-device component. A characteristic here, however, is that an electrolysis cell is of substantially two-dimensional shape, i.e., has shallow dimensions, and a multiplicity are assembled to form an electrolysis cell stack and to form an electrolyzer.

In these applications under high pressure in conjunction with decidedly shallow dimensions, therefore, a large number of electrolysis cells of largely identical construction have to be stacked. In light of this multiplicity of largely identical and standardizable components, it is necessary for example for the cell frame of an electrolysis or a fuel cell or other galvanic cells to be as inexpensive as possible.

It is especially significant as well that any kind of contamination triggers adverse effects in the electrochemical cell: in particular, efficiency losses and heightened corrosion. This must be avoided. To that end, the process medium within the electrochemical cell should have as little contact as possible with ion donors—for example, base metals, glass fiber ceramic, etc. Aggressive media may leach ions from glass fibers, stainless steels, etc. It is very difficult and costly to use precious metals to produce stable components for relatively high internal pressures. Designing such components from chemically stable materials (high-performance plastics, such as PPS—polyphenylene sulfide—for example), on the other hand, also leads to high levels of deformation (and usually failure) under high loads, owing to the low elasticity moduli and tensile strengths.

European patent application EP 0 991 818 A1 relates to a high-pressure electrolyzer. The high-pressure electrolyzer comprises a plurality of electrolysis chambers which are held in a frame. These electrolysis chambers are each separated by a membrane. Electrodes are pressed onto this membrane. Electrodes are connected electrically to a bipolar plate via a metal fabric. Despite fundamental mention of a frame which holds electrolysis chambers, this publication does not show that the loads or forces occurring in routine-service operation of the high-pressure electrolyzer are actually neutralized by the frame. As for a component or a structure providing the high-pressure electrolyzer with stability, the European patent application provides no information. Moreover, the problem of the ingress of extraneous ions into the electrolysis chamber in connection with pressure electrolyzers is not dealt with in EP 0 991 818 A1.

The requirement for the loads, pressures or pressure forces occurring during operation to be accommodated poses both a barrier and a considerable cost factor. For this reason, there is a need to provide an operationally stable electrochemical cell for a high-pressure electrolyzer that is simple and inexpensive to produce while on the one hand being able to accommodate the required pressure loads and to withstand these loads in operation and on the other hand, at the same time, avoiding efficiency losses due to degradation.

It is an object of the invention to specify an electrochemical cell which is designed for high-pressure operation, taking account not only of cost aspects but also of influences which limit lifetime.

This object is achieved in the invention by an electrochemical cell for a high-pressure electrolyzer, comprising a closed cell frame composed of a high-pressure-resistant first material, an electrochemical reaction region which is arranged completely within the cell frame and comprises an anodic half-cell and a cathodic half-cell, an intervening space which spatially separates the reaction region from the cell frame, and a second material incorporated in the intervening space, the second material being an electrical insulator and the second material having a low diffusion coefficient in respect of ingress of extraneous ions into the reaction region.

The invention takes as its very starting point the realization that in known approaches at the level of an electrochemical cell intended specifically for use in a high-pressure electrolyzer, hardly any attention has been paid so far to the problem of avoiding degradation phenomena, especially in relation to harmful corrosion effects and ingress of extraneous ions into the reaction region during operation of the cell. In particular, there have been no proposals to date, in conventional approaches, for solutions that are both effective and sustainable. Instead, the problem of corrosion has continued to persist, this being detrimental to the service life of a high-pressure electrolyzer.

Accordingly, for a pressure electrolysis, in general decidedly complex metal components and elaborate supporting structures have to date been proposed—solely from the standpoint of the high operating pressure, but entirely robust and functional components—which, for example, have been chamfered or otherwise comprehensively machined. This denotes a considerable financial or economic investment outlay in costs for materials and for manufacture. A problem here is that these very metal components, and also other components, in the vicinity of the reaction region of the electrochemical process in a cell act as ion donors, meaning that they can emit ion—generally metal cations—which then diffuse into the reaction region of the cell, where they migrate as harmful contaminants, so-called extraneous ions, into the process and into the cell circuit, subjecting them to loading. This leads to efficiency losses and lifetime-limiting effects on the cell, i.e., in particular on the fluid-carrying components of the anodic half-cell and of a cathodic half-cell, such as, for instance, conduits, channels, electrodes.

It has emerged that relatively high levels of contaminants may be introduced into the electrochemical process, into the cell, by in some cases even alternative, nonmetallic materials, for instance injection-molded components containing short glass fibers, as a result of the injection molding process and of fiber contact.

Since an electrochemical cell and an electrolyzer consist of numerous components of the same kind, an important aspect is not only that of economic manufacture in high quantities, but also that of degradation effects in relation to the technically and economically attainable lifetime in operation, especially after extraneous ion ingress. This is exacerbated by the fact that the requirements are more exacting in any case with high-pressure electrolysis.

The present invention now takes account of both aspects for the first time and proposes, for an electrochemical cell designed specifically for high-pressure operation, that there is functional division or separation into multiple components. This is a considerable advantage over one or more assembled metal components as a pressure-resistant housing with perhaps an elaborate supporting construction.

The basic approach to the design of the electrochemical cell for high-pressure application is that of a shell construction, and so the central reaction region is surrounded and protectively encased by the intervening space, which is surrounded in turn by the closed cell frame. For contact with the process media—reactants and products in the context, for instance, of a water electrolysis—and the routing of these process media, the second material in the intervening space is chosen deliberately without potential sources of contamination in respect of the ingress of extraneous ions. At the same time, in light of the spatial separation, any migration resulting from diffusion of harmful extraneous ions, metal cations for example, of the first material from the cell frame into the reaction region is prevented or very largely suppressed. The second material in the intervening space here constitutes an effective diffusion barrier, and its layer thickness can be designed, through the thickness of the second material, in line with the specific requirements and the choice of first and second materials. The aim here is for solid-state diffusion coefficients of the second material, in respect of the diffusion of ions from the first material through the second material, of as far as possible less than 1.0 to 10.0×10⁻¹³ m²/s, advantageously indeed less than 10.0×10⁻¹³ m²/s. The second material in the intervening space therefore shields the reaction space from ingress of extraneous ions from the cell frame. Furthermore, the second material as such is already selected such that it has no inherent tendency toward harmful diffusion into the central reaction region. The second material is chosen to be an electrical insulator and for that reason, as a nonmetal, is ruled out from the start as being a source of metal cations. As well as the diffusion-inhibiting effect, important factors still include the mechanical properties of the second material in the intervening space and the effect thereof in relation to the pressure forces; this is elucidated below.

As well as the problem of extraneous ions, indeed, the invention also provides particularly advantageous solutions to the accommodation of the pressure forces, through the shell construction, and to the functional separation of the interlayer and the cell frame. In operation, the high internal pressure forces are guided outward in radial direction from the second material in the intervening region possibly to a further material in the intervening region. The further material is required only to accommodate the pressure forces or to transmit these forces, without coming into media contact with the process media in the reaction space. An alternative option is, however, for the pressure forces to be transferred from the second material directly to the closed cell frame composed of the high-pressure-resistant first material. The pressure forces can therefore be transmitted through the intervening space either indirectly or directly from the first material to the second material, depending on whether there is an optional further material, as well as the second material, incorporated in the intervening space. In any case, the cell frame with the high-pressure-resistant first material accommodates the pressure forces, and the reaction region of the electrochemical high-pressure cell is protected. It is therefore possible for a further material, as well as the second, diffusion-inhibiting material, to be incorporated in the intervening space for force mediation and for protecting the first material. In this variant embodiment, the intervening space is itself subdivided into two regions or shells. Hence, advantageously, it would also be possible to specifically configure the further material with optionally less exacting, or adapted, requirements in terms of diffusion inhibition and attachment to the cell frame.

In a particularly preferred configuration of the invention, the second material completely surrounds the reaction region and seals it off relative to the cell frame. As a result of the enclosure, a particularly effective diffusion barrier and protective effect for the reaction region of the electrochemical cell is achieved. The intervening space here is preferably completely full of the second material, and so the second material borders on the cell frame, more particularly bordering on it directly. As a result, the second material, as well as the diffusion barrier effect, functions additionally and on its own as filling material which conducts pressure force and completely fills the intervening space. This is a particularly simple and cost-effective configuration for the high-pressure cell. It also provides high flexibility and adaptability to the respective geometry, even in the case of a two-part embodiment with two parts in the intervening space that are producible and configurable interengagingly in a form-fitting manner with, for instance, tongue and groove, or offset sealing lip, by injection molding, and so the intervening space is completely filled and the second material borders on the cell frame.

For particular efficacy both as diffusion inhibitor and as force conductor for the pressure forces, the second material, in a preferred configuration, comprises an unreinforced plastic which is selected more particularly from the group of the plastics polyamide, polycarbonate, polyethylene or polymethylene or polypropylene. Also possible here is the use of combinations or mixtures of the stated plastics to form a material mix, as the second material.

In a further-preferred configuration, the first material is a metal, a ceramic, a glass fiber ceramic or a composite of two or more integrated materials. The cell frame is the component that ultimately accommodates the pressure of forces which are transmitted radially outward from the reaction region via the intervening space to the cell frame. The focus here is predominantly on the mechanical properties and the pressure resistance. Metals, for example, can be employed here advantageously. Known and simple manufacturing processes for material working are available, such as, for instance, waterjet cutting of a metal component or substantially two-dimensional metal plates, as typically for the cell frame of an electrochemical cell. However, composite materials or ceramics can also be employed, and are easy to machine with corresponding machine tools.

There is preferably a seal provided in the intervening space that completely surrounds the second material, and so an inner intervening space containing the second material is formed and an outer intervening space sealed off relative to the inner intervening space by the seal is formed and completely surrounds the inner intervening space. Because of this, a two-part configuration is achieved for the intervening space itself to enable, advantageously, a further functional adaptation of the structure in the intervening space, as and when required, more particularly a greater flexibility in the choice of material. The inner intervening space with the second material here additionally and advantageously fulfills the above-described functions of a diffusion barrier and also a force conductor for the pressure forces. The seal therefore closes off the inner intervening space completely from the outer intervening space, so retaining the protective function for the reaction region and the diffusion barrier effect. The outer intervening space can therefore be adapted specifically for further circumstances, possibly involving less exacting requirements in terms of the diffusion and more exacting requirements in terms of the force conduction and pressure resistance. This two-part functional division of the intervening space is beneficial for the manufacturing costs of an electrochemical cell for high-pressure operation.

In that case then, for instance, it is possible preferably for a reinforced plastic, more particularly a glass fiber-reinforced plastic, to be incorporated in the outer intervening space.

Preferably, in addition, the outer intervening space may be completely full of a reinforced plastic, and so the reinforced plastic borders flush on the cell frame.

In one particularly preferred configuration, the cell frame has a round or elliptical shape, and so in operation the pressure forces resulting from a high operating pressure in the reaction region can be transmitted via the intervening space in radial direction to the cell frame, and so there a force transformation into tensile forces is produced.

Owing to the round or elliptical shape, a force transformation of the pressure forces acting radially from inside to outside, into tangential forces, is achieved, this being very advantageous for the design and for use in a high-pressure electrolyzer. The force-accommodating component, i.e., the cell frame, transforms the radial forces into tensile forces so making it possible to achieve an unambiguous and easy-to-calculate condition and also a mechanical configuration which is readily manageable technically. Here, in established fashion, the known Barlow's formula can be employed, which indicates the mechanical stresses in rotationally symmetrical bodies loaded by internal pressure, of the kind encountered, for example, in pipes or pressure vessels. The formula is based, as the membrane stress, on a force equilibrium, meaning that neither deformation assumptions nor elasticity variables are necessary in order to calculate the stresses.

Barlow's formula applies only to curved, thin-wall pressure vessels. For boilers produced from planar sheets or plates, and for thick-wall cylindrical vessels, Barlow's formula is not applicable or is applicable only as a (rough and ready) approximation. Accordingly, a round or, preferably, elliptical shape of the cell frame proves particularly advantageous.

Here, preferably, the cell frame has a partable or adjustable screw connection, and so mechanical adaptation to the components arranged within the cell frame is achievable. Manufacturing advantages result from this configuration, since precise and individual adaptation through the adjustment of the screw force, and precise adaptation of the annular pressing of the material, which acts over the entire periphery and is extremely uniform, in the intervening space are achievable, this being the case for an individual cell. The partable connection also has advantages in the event of servicing, as for instance on replacement or disassembly of an electrochemical cell.

In a particularly preferred configuration, therefore, the electrochemical cell is embodied as an electrolysis cell for water electrolysis. Water electrolysis is used, for example, to break down water into hydrogen and oxygen in the electrolysis cells, this being regarded in the future, as part of the energy transition, as a particularly interesting pathway for the conversion of renewable energies and the energetic storage thereof in the form of chemical energy in the hydrogen.

A further aspect of the invention is its application in the context of a cell stack having a number of electrochemical cells arranged consecutively along an axial stacking direction.

The modular structure of the electrochemical cell allows a multiplicity of electrochemical cells to be assembled to form a cell stack, so making the electrolysis power scalable in a particularly simple way and also allowing the production rate of hydrogen or, alternatively, other product gases to be adapted. A cell stack having a very large number of electrochemical cells or electrolysis cells connected electrically, mechanically and fluidically, 50 to 100 cells for example, is also referred to as an electrolysis module.

The electrolysis power for the operation of the electrolysis plant is provided by the energy source, which for this purpose can be connected at respective opposite ends of the cell stack. In a cell stack there may be a multiplicity of electrolysis cells arranged—for example, more than 100 electrolysis cells, more particularly several hundred electrolysis cells, but preferably not more than about 400 electrolysis cells. In the case of electrolysis of water to hydrogen and oxygen, an electrical voltage at a respective one of the electrolysis cells is about 1.5 V to 2.5 V. The resulting electrical voltage on the cell stack is the corresponding product of this, and so the electrical voltage on the cell stack frequently exceeds 100 V, and may even be several hundred volts.

In a preferred configuration, in the case of the cell stack, the consecutively arranged electrochemical cells are contacted electrically with one another directly, for instance by mechanical pressing of the electrical contacts. The pressing of the substantially two-dimensional electrochemical cells advantageously produces not only electrical contacting but also a pressuretight mechanical connection.

In the case of a cell stack, the cell frame and the material bordering on the cell frame in the intervening space preferably have a chamfer, and so mechanical tolerance compensation and also stabilization are achieved. This chamfering is particularly advantageous in the context of a cell frame which is configured as an encircling ring—annularly or elliptically—which narrowly surrounds the material in the intervening space. Accordingly, in manufacture, an exact fitting of the two components is achievable, which is highly desirable. Corresponding chamfering of the directly mutually bordering contact faces of cell frames, and of the encircling ring, respectively, and the material bordering thereon in the intervening space, provides for tolerance compensation and an intrinsic mechanical and thermomechanical stability, which is advantageous for the high-pressure application with operating pressures of 30 bar to 50 bar and also, furthermore, from standpoints of operational safety and availability.

In the context of the cell stack, preferably, the cell frame has a metal cable wound around the bordering material in the intervening space in a continuous strand, or has a tensioning strap or a welded strap. This is a particularly simple and cost-effective configuration for accommodating the adopted radial pressure forces from the intervening space and transforming them into tangentially acting tensile forces in the encircling wall of the cell frame, which is formed preferably as a continuous cable strand.

A further particular aspect of the invention is the preferred use of the cell stack in the context of a high-pressure electrolyzer. The high-pressure electrolyzer of the invention enables high-pressure operation and at the same time, as a result of the construction, it is possible advantageously to avoid harmful attacks due to ingress of extraneous ions into the electrolysis process of the high-pressure electrolyzer.

Besides the cell stack, the high-pressure electrolyzer preferably comprises further components, such as, for example, pumps, heat exchangers, separation vessels, which are needed for the routine-service operation of the high-pressure electrolyzer and/or of the electrochemical cells. These components may also be in collective form as a so-called cell supply unit for supplying the electrolysis cells for routine-service operation with at least one operating medium—water in the case of water electrolysis, for example.

The invention is elucidated more closely below with reference to the appended drawings. In this context it should be borne in mind that the exemplary embodiments represented in the drawings serve primarily to elucidate the invention. They are intended, however, not to limit the invention.

In these drawings, schematically and in greatly simplified form:

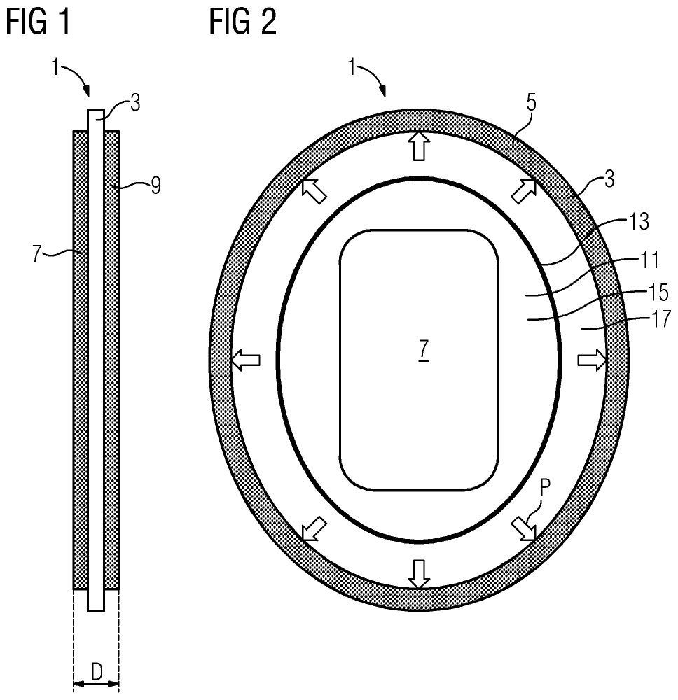

FIG. 1 shows a side view of an electrochemical cell;

FIG. 2 shows a plan view of the electrochemical cell shown in FIG. 1;

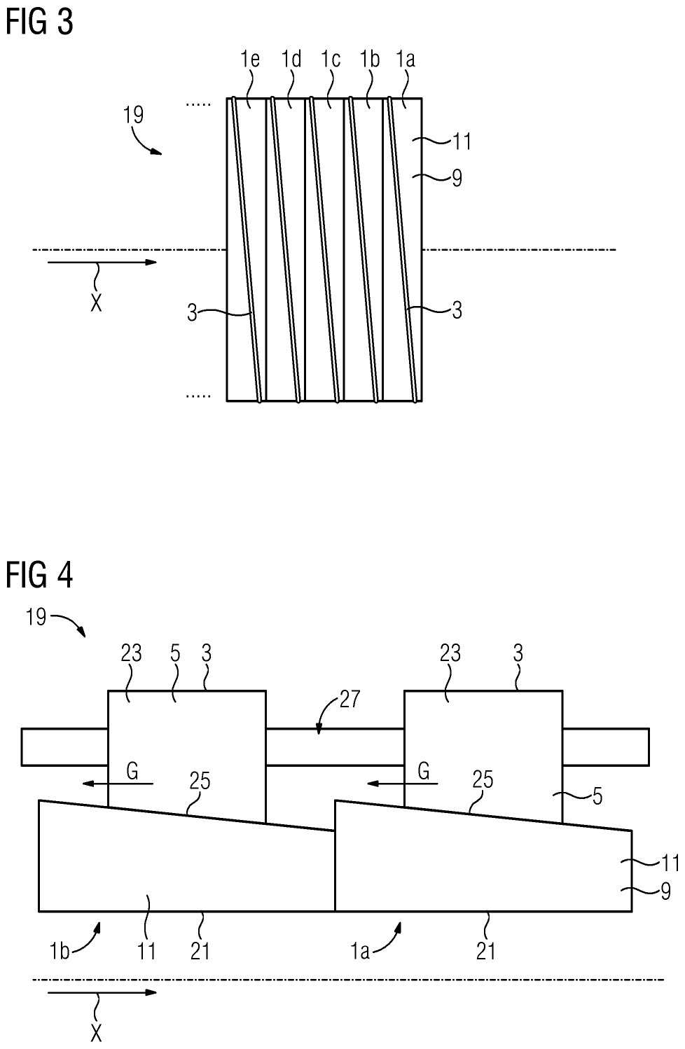

FIG. 3 shows, in a detail, a side view of a cell stack having a multiplicity of electrochemical cells;

FIG. 4 shows, in a side view, a cell stack in a detail having two electrochemical cells.

FIG. 1 shows an electrochemical cell 1 in a side view. The electrochemical cell 1 here is a substantially two-dimensional structure having, in the side view shown, a markedly lower height or thickness D than in the other two spatial dimensions perpendicular to the thickness, i.e., the length and width. This permits stacking and electrical and fluidic assembly of multiple electrochemical cells 1. The electrochemical cell 1 comprises a cell frame 3 and also a region which is completely surrounded by the cell frame 3 and is arranged radially inward in relation to the cell frame 3. This region borders immediately on the cell frame and forms an intervening space 9. Viewed radially inward of the cell frame 3 and of the intervening space 9, a reaction region 7 is provided which is arranged centrally or in the middle. In the operation of the electrochemical cell 1, the conversion processes take place in the reaction region 7, comprising for example the breaking down of water into oxygen and hydrogen, with direct electrical current of corresponding polarity being supplied. For this purpose, in the reaction region 7, a likewise substantially two-dimensional anodic half-cell, not represented in more detail, and a substantially two-dimensional cathodic half-cell are arranged immediately adjacent to one another. The half-cells are separated, for example, by a membrane to ensure their function. In a PEM electrolysis, typically, distilled water is supplied as reactant on the anode side and is split into hydrogen and oxygen at a proton-permeable membrane (proton exchange membrane; PEM). The water here is oxidized to oxygen at the anode. The protons pass through the proton-permeable membrane. Hydrogen is produced on the cathode side. The water here is generally conveyed from a bottom side into the anode space and/or cathode space. In a pressure electrolysis or high-pressure electrolysis, the membrane is generally loaded by strong pressure forces, if there are differential pressures between the anodic half-cell and the cathodic half-cell. In order to prevent this, it is more favorable to place the central reaction region 7 within the cell frame 3 and the intervening space 9 under the same high operating pressure, requiring the electrochemical cell 1 to be designed for high pressure.

FIG. 2 shows a plan view of the electrochemical cell 1 represented in FIG. 1. Arranged in radial direction as viewed from inside to outside, one after another in shell form, centrally in the middle, are the reaction region 9, the intervening space 9 and the cell frame 3. The intervening space 9 completely surrounds the reaction region 9. The intervening space 9 has an annular, pressure-resistant seal 13 running completely around, and so the intervening space 9 is divided functionally into an inner intervening space 15 and an outer intervening space 17, sealed off from one another. The seal may be an O-ring, for example. The cell frame 3 comprises a first material 5, implemented as metal of corresponding wall thickness as an encircling wall, to enable the high pressure forces P in operation to be accommodated. The first material may alternatively also comprise or consist of a ceramic, a glass fiber ceramic or a composite of two or more integrated materials. Incorporated in the inner intervening space is a second material 11. The second material 11 is an electrical insulator and has a low diffusion coefficient in respect of a harmful ingress of extraneous ions into the reaction region 9. The second material 11 consists of an unreinforced plastic, alternatively from the group of the plastics polyamide, polycarbonate, polyethylene or polymethylene or polypropylene, or mixtures thereof.

The second material 11 in the inner intervening space 9 here constitutes an effective diffusion barrier, and its layer thickness can be designed, through the thickness of the second material 11, in line with the specific requirements and the choice of the first material 5 and the second material 11. The aim here is for solid-state diffusion coefficients of the second material 11, in respect of the diffusion of ions from the first material 5 through the second material 11, of as far as possible less than 1.0 to 10.0×10⁻¹³ m²/s, advantageously indeed less than 10.0×10⁻¹³ m²/s. The second material 11 in the intervening space 9 therefore shields the reaction region 7 from ingress of extraneous ions from the metallic cell frame 3. Furthermore, the second material 11 as such is already selected such that it has no inherent tendency toward harmful diffusion into the central reaction region 7.

Viewed in radial direction outwardly of the seal 13, in the exemplary embodiment, is the outer intervening space 17, arranged between the inner intervening space 15 and the cell frame 3.

The latter is sealed relative to the inner intervening space (15) by the seal (13). The outer intervening space (17) here completely surrounds the inner intervening space (15). Incorporated in the outer intervening space (17) is a reinforced plastic, more particularly a glass fiber-reinforced plastic, with the outer intervening space (17) being completely full of a reinforced plastic, and so the reinforced plastic borders flush on the cell frame (3). As a result, the radial pressure forces P are effectively transmitted. The cell frame (3) has a round or elliptical shape, and so in operation, the pressure forces P can be transmitted in radial direction to the cell frame (3) via the intervening space (9) as a result of a high operating pressure in the reaction region (7), and so a force transformation into tensile forces, which can be managed more effectively, is produced there. This is a particularly favorable shaping for the high-pressure application of the electrochemical cell 1.

As a result of the material-adapted shell construction or multilayer construction and the functional separation of the intervening space 9 and the cell frame 3, not only is the ingress of extraneous ions into the reaction region 7 effectively prevented, but also an effective accommodation of the pressure forces P is brought about in a particularly advantageous way. In operation, the very high internal pressure forces P are guided outwardly in radial direction from the second material (11) in the inner intervening space 15 to a further material in the outer intervening space 17. The further material only has to accommodate the pressure forces P and/or to transmit these pressure forces P to the cell frame 3, without coming into media contact with the process media in the reaction region 7. As a result, the reaction region 7 is effectively protected from loading with extraneous ions and at the same time relieved of differential pressure forces.

FIG. 3 shows in a detail, in a greatly simplified representation, a side view of a cell stack 19 having a plurality of electrochemical cells 1. Here, in the cell stack 19, a number of electrochemical cells 1a, 1b, 1c, 1d, 1e arranged consecutively along the axial stacking direction X, are stacked one atop another and firmly connected to one another. In this case, adjacently consecutively arranged electrochemical cells 1a, 1b, 1c, 1d, 1e are pressed directly by mechanical pressing in each case and hence at the same time are contacted electrically with one another. The cell frame 3 has a metal cable which is wound around the material in the intervening space 9 in several turns. The metal cable contacts and surrounds the material in the intervening space 9 here over the full circumference and intimately, so that the metal cable produces effective force accommodation and force transformation of the radial pressure forces into tensile forces. For reasons of representation, the turns of the metal cable are shown here with a spacing. It is, however, possible and very advantageous for the metal cable to be wound closely and flush, in a continuous strand, around the material in the intervening space 9, so that each turn lies against the next without any spacing. It is also possible—in analogy to an electrical coil—for multiple plies or windings of metal cable to lie one above another. This is flexibly adaptable to the size of the pressure forces P to be accommodated by the cell frame 3, through the cell frame. The ends of the metal cable are tensioned, to establish a pre-stress, and so the material in the intervening space 9 is closely encircled and pressed. This produces effective force transmission and force transformation. The metal cable configuration has the advantage that metal cables are able to accommodate tensile forces well. Moreover, for purposes of service and inspection, the partability thereof is good, and so, as and when correspondingly required, simple access to the further components of the electrochemical cell 1 is possible.

Alternatively or additionally, the cell frame 3 may also be furnished using a tensioning strap (encircling strap) or a welded strap, in order to achieve the desired intimate containment and the enclosure of the material in the intervening space 9, and a predetermined pressing. It is also possible to provide a portable encircling ring or tensioning ring, which is placed around the material of the intervening space 9. To fine-tune and adjust the fit and pressing force, the tensioning ring has an opening which is adjustable and closable via a screw connection. In that case, in correlation with the number of cells in the cell stack 19, a multiplicity of tensioning rings are placed alongside one another around the material in the intervening space 9 in axial direction X and tensioned individually.

FIG. 4 shows, in a side view, a cell stack 19 in a detail with two electrochemical cells 1a, 1b. The electrochemical cells 1a and 1b are pressed closely to one another and arranged along the axial direction X. Based on a radial direction perpendicular to the axial direction X, the cell frame 3 of the respective cell 1a, 1b respectively forms an outer component 23. The outer component 23 comprises the first material 5. Arranged in the intervening space 9, accordingly, is an inner component 21. The inner component 21 comprises the second material 11. The cell frame 3 and the first material 5 in the intervening space, bordering the cell frame 3, each have a chamfer 25, thereby producing mechanical tolerance compensation and also stabilization. The chamfer 25 is introduced by a corresponding bevel respectively on the inner component 21 and on the outer component 23. As a result, in relation to the axial stacking direction X of the cells 1a, 1b, sloping and correspondingly smooth sliding faces are provided for the inner component 21 and the outer component 23. This facilitates assembly of a cell stack 19 from multiple electrochemical cells 1a, 1b and the very precise positioning of the cells. The chamfer 25 ensures corresponding sliding faces, allowing an axial sliding force G to be applied in order to press and to tension the cells 1a, 1b. Through the chamfer 25, manufacturing tolerances across the multiplicity of cells 1a, 1b in a cell stack 19 can be compensated, and self-positioning and/or self-locking is promoted. In addition to the chamfer 25 it is possible—as shown in FIG. 4—for an additionally tolerance-compensating tensioning element 27 to be provided in axial direction X, this element connecting the outer components 23 of the cell frame 3 to one another. This tensioning element 27 is elastic, made of metal, for example, and ensures a resilience force and positioning in cooperation with the chamfer 25. The tensioning element may be a metal rod or a metal cable, alternatively also two or more distributed uniformly over the periphery of the cell stack. Accordingly, operationally related tolerances due for instance to thermomechanical expansions as a consequence of changes in pressure or temperature can also be easily compensated.

1-16. (canceled)

17. An electrochemical cell for a high-pressure electrolyzer, comprising:
a closed cell frame composed of a high-pressure-resistant first material;
an electrochemical reaction region disposed completely within said closed cell frame and having an anodic half-cell and a cathodic half-cell;
an intervening space spatially separating said electrochemical reaction region from said closed cell frame; and
a second material incorporated in said intervening space, said second material being an electrical insulator and said second material having a low diffusion coefficient in respect of ingress of extraneous ions into said electrochemical reaction region.

18. The electrochemical cell according to claim 17, wherein said second material completely surrounds said electrochemical reaction region and seals said electrochemical reaction region off relative to said closed cell frame.

19. The electrochemical cell according to claim 17, wherein said intervening space is completely full of said second material, and therefore said second material borders on said closed cell frame.

20. The electrochemical cell according to claim 17, wherein said second material contains an unreinforced plastic selected from the group consisting of: polyamides, polycarbonates, polyethylene, polymethylene and polypropylene.

21. The electrochemical cell according to claim 17, wherein said high-pressure-resistant first material contains a metal, a ceramic, a glass fiber ceramic or a composite of two or more integrated materials.

22. The electrochemical cell according to claim 17, further comprising a seal disposed in said intervening space that completely surrounds said second material, and so an inner intervening space containing said second material is formed and an outer intervening space sealed off relative to said inner intervening space by said seal is formed and completely surrounds said inner intervening space.

23. The electrochemical cell according to claim 22, wherein a reinforced plastic is incorporated in said outer intervening space.

24. The electrochemical cell according to claim 22, wherein said outer intervening space is completely filled with a reinforced plastic, where said reinforced plastic borders flush on said closed cell frame.

25. The electrochemical cell according to claim 17, wherein said closed cell frame has a round or elliptical shape, and in operation pressure forces resulting from a high operating pressure in said electrochemical reaction region are transmitted via said intervening space in a radial direction to said closed cell frame, and therefor a force transformation into tensile forces is produced.

26. The electrochemical cell according to claim 25, wherein said closed cell frame has a partable or adjustable screw connection, and so mechanical adaptation to components disposed within said closed cell frame is achievable.

27. The electrochemical cell according to claim 17, wherein the electrochemical cell is an electrolysis cell for water electrolysis.

28. The electrochemical cell according to claim 23, wherein said reinforced plastic is a glass fiber-reinforced plastic.

29. A cell stack, comprising:
a plurality of electrochemical cells disposed consecutively along an axial stacking direction, each of said electrochemical cells containing:
a closed cell frame composed of a high-pressure-resistant first material;
an electrochemical reaction region disposed completely within said closed cell frame and having an anodic half-cell and a cathodic half-cell;
an intervening space spatially separating said electrochemical reaction region from said closed cell frame; and
a second material incorporated in said intervening space, said second material being an electrical insulator and said second material having a low diffusion coefficient in respect of ingress of extraneous ions into said electrochemical reaction region.

30. The cell stack according to claim 29, wherein consecutively disposed said electrochemical cells are contacted electrically with one another directly.

31. The cell stack according to claim 29, wherein said closed cell frame and said second material bordering on said closed cell frame in said intervening space have a chamfer which achieves mechanical tolerance compensation and also stabilization.

32. The cell stack according to claim 29, wherein said closed cell frame has a metal cable wound around said second material in said intervening space in a continuous strand or has a tensioning strap or a welded strap.

33. The cell stack according to claim 30, wherein consecutively disposed said electrochemical cells are contacted electrically with one another directly by mechanical pressing.

34. A high-pressure electrolyzer, comprising:
said cell stack according to claim 29.
